(19) United States
(12) Patent Application Publication
(10) Pub. No.: US 2006/0248078 A1
(43) Pub. Date: Nov. 2, 2006

(54) Search engine with suggestion tool and method of using same

(76) Inventors: William Gross, Pasadena, CA (US); Jason D. Levine, Los Angeles, CA (US); Gladys Kong, Pasadena, CA (US)

Correspondence Address: CHRISTIE, PARKER & HALE, LLP, PO BOX 7068, PASADENA, CA, 91109-7068, US

(21) Appl. No.: 11/404,944

(22) Filed: Apr. 14, 2006

Related U.S. Application Data
(60) Provisional application No. 60/671,614, filed on Apr. 15, 2005.
(60) Provisional application No. 60/780,785, filed on Mar. 8, 2006.

(51) Int. Cl. G06F 17/30; G06F 7/00

(52) U.S. Cl. 707/5; 707/7

(57) ABSTRACT

A method and a tool for suggesting search terms and other information during information search based on characters entered by users. Search terms may be suggested based on a heuristic that may take into account frequency of use and indexing of a database.

### CROSS-REFERENCE TO RELATED APPLICATIONS

This application claims priority to and the benefit of U.S. Provisional Application No. 60/671,614 entitled “SEARCH ENGINE WITH KEYWORD SUGGESTION TOOL” and filed Apr. 15, 2005 and U.S. Provisional Application No. 60/780,785 entitled “IMPROVED SEARCH ENGINE WITH KEYWORD SUGGESTION TOOL” and filed Mar. 8, 2006, the entire contents of both of which are incorporated by reference herein.

### FIELD OF THE INVENTION

This invention relates to a tool for providing keyword suggestions to a user, and a search engine using the same.

### BACKGROUND

When using traditional search engines, a user (e.g., a searcher) must enter one or more keywords to initiate a query to look for desired information. In many instances, the keyword that he is entering is not necessarily the keyword that will lead to the desired search result. Hence, the user typically must enter a number of different keywords and/or keyword combinations during multiple queries to realize a desired search result.

As such, the user often must spend time and effort to identify new keywords and/or modify the keywords used during the queries to obtain the desired search result. This necessarily is a tedious and time consuming process, and there is no guarantee that the user will eventually determine the one or more keywords that can provide the desired search result.

### SUMMARY OF THE INVENTION

In one embodiment of the present invention, a method for providing support during information search includes: receiving one or more characters from a user; comparing the one or more characters to a set of search terms, wherein each of the search terms is associated with a query previously submitted by the user of a prior user; selecting a subset of one or more search terms within the set of search terms based on the one or more characters; and returning one or more suggested queries to the user, each of the queries being associated with the subset of one or more search terms.

In another embodiment of the present invention, a tool for providing support during information search comprises: a first interface for receiving one or more characters from a user; a processor adapted to compare the one or more characters to a set of search terms, wherein each of the search terms is associated with a query submitted by a prior user, and select a subset of one or more search terms within the set of search terms based on the one or more characters using a selection heuristic; and a second interface adapted to return one or more suggested queries to the user, each of the queries being associated with the subset of one or more search terms.

In yet another embodiment of the present invention, a computer program product for providing support during information search includes: computer readable software for receiving one or more characters from a user; computer readable software for comparing the one or more characters to a set of search terms, wherein each of the search terms is associated with a query submitted by a prior user; computer readable software for selecting a subset of one or more search terms within the set of search terms based on the one or more characters using a selection heuristic; and computer readable software for returning one or more suggested queries to the user, each of the queries being associated with the subset of one or more search terms.

These and other aspects of the invention will be more readily comprehended in view of the discussion herein and accompanying drawings.

### BRIEF DESCRIPTION OF THE DRAWINGS

FIGS. 1-8 are screen shots of a web browser that illustrate the operation of the keyword suggestion tool in an exemplary embodiment according to the present invention.

FIG. 1 shows the web browser before entry of any characters in the keyword field.

FIG. 2 shows the web browser after a single character has been entered in the keyword field.

FIG. 3 shows the web browser after three characters of a search term have been entered in the keyword field.

FIG. 4 shows the web browser after four characters of a search term have been entered in the keyword field.

FIG. 5 shows an embodiment of the web browser where, after four characters of a search term have been entered in the keyword field, the system suggests another spelling.

FIG. 6 shows the embodiment of FIG. 5 after an entire word has been entered in the keyword field.

FIG. 7 shows the web browser after a search term has been entered in the keyword field and a selection has been made in the keywords area.

FIG. 8 shows the web browser after a search term has been entered in the keyword field and a further selection has been made in the keywords area.

FIG. 9 shows a flow chart illustrating interaction with and behavior of an embodiment of a tool in accordance with the present invention.

FIG. 10 shows an architectural overview of an embodiment of a system in accordance with the present invention.

FIGS. 11-15 are screen shots of an alternate embodiment of a web browser that illustrates the operation of a keyword and other suggestions tool in accordance with the present invention.

FIG. 11 illustrates the tool's “official site” feature.

FIG. 12 illustrates the tool's news feature.

FIG. 13 illustrates the tool's synonyms feature.

FIG. 14 illustrates the tool's reconciliation feature.

FIG. 15 illustrates the tool's map feature.

FIGS. 16-17 illustrate the tool's company information feature.

FIG. 18 shows a flow chart illustrating interaction with and behavior of an embodiment of a system in accordance with the present invention similar to FIG. 9, but including suggestions other than keywords or alternative spellings.

FIGS. 19-22 illustrate screenshots of the user interface of the keyword suggestion tool with hierarchical refinement of the suggested queries.

FIG. 23 illustrates a screenshot of the user interface of the keyword suggestion tool for providing fact content.

FIG. 24 illustrates a screenshot of the user interface of the keyword suggestion tool for providing news content.

FIG. 25 illustrates a screenshot of the user interface of the keyword suggestion tool for providing stock content.

FIG. 26 illustrates a screenshot of the user interface of the keyword suggestion tool for providing weather content.

### DETAILED DESCRIPTION

In an exemplary embodiment of the present invention, a keyword suggestion tool is provided. The keyword suggestion tool provides suggested keywords based on the alphanumeric characters or keys typed by the user. The keyword suggestion tool has an “as fast as you type” feature which is used to provide suggested keywords in real time as the user is typing in the keyword character by character, i.e., the keyword suggestion tool provides suggested keywords in real-time or instantaneously as the user is typing or entering alphanumeric characters on a keyboard or a keypad. The system and method for implementing and using the “as fast as you type” feature is disclosed in U.S. patent application Ser. No. 10/654,596 entitled “Methods and Systems for Web-Based Incremental Searches” filed Sep. 3, 2003, the entire content of which is incorporated herein by reference.

The keyword suggestion tool may include and/or may be coupled to a database of keywords or search terms. In the exemplary embodiment, the keywords of the database are derived from queries that have been used during past searches by the user and/or others. In some embodiments, the database comprises a list of common words, common phrases, the queries of users of different search engines, or a combination thereof.

The keyword suggestion tool indexes the database while the user types the keywords or portions thereof, identifies the keywords or queries that match the characters entered by the user, and returns suggested keywords that can be used for keyword searches. The suggested keywords, or portions thereof, preferably include one or more words or phrases derived from prior queries that include the same one or more keywords already entered by the user. Each of the keywords returned or suggested by the keyword suggestion tool may be a hyperlink, e.g., a hypertext link, that can be selected by the user and used to perform a search using a simple mouse click.

In another exemplary embodiment of the present invention, a search engine including the keyword suggestion tool is provided.

In an embodiment, an auto-completion feature is provided. The auto-completion feature can complete the search term or search string in the keyword field as the user is entering the characters that make up the search term or search string. The suggested keywords provided by the auto-completion feature may be generated using predictive text technology known to those skilled in the art or generated from prior search information.

In the preferred embodiment, the one or more complete terms or query generated by the keyword suggestion tool and auto-completion feature are identified by comparing the entered characters with a database of words. The database of words preferably includes a list of individual words and/or phrases selected from the group consisting of: the queries of users of the associated search engine, the queries of users of a different search engine, the individual search terms of the queries previously submitted by users of the same or different search engine, common words from a dictionary, for example, common phrases, and combinations thereof.

In another embodiment, a search result is displayed when a user places a cursor on a corresponding keyword suggested by the keyword suggestion tool. Hence, for example, the content of a search result area may be updated with a new search result in response to the user placing a cursor on the keywords listed in a keyword area.

As used herein, the terms “keywords” and “search terms” are synonymous and may be interchanged with each other. Each of the keywords, in turn, comprises one of more alphanumeric characters that may form a complete word or a portion of a complete word. Further, the term “query” may be used herein to refer to one or more keywords or one or more search terms. When a user submits a query, the keyword suggestion tool matches the characters of the query with keywords or search terms in its database.

A search on the Internet search engine of the preferred embodiment can be initiated simply by selecting (e.g., via keyboard or mouse click) one of the suggested queries or keywords returned by the keyword suggestion tool. By way of example, the keyword suggestion tool may provide the user with one or more suggested keywords as hypertext links, each hyperlink being a command adapted to invoke a search in the database for the associated keyword. When a search is executed with a selected search term, the search engine generates search results including a plurality of web pages and other resources. In addition, the keyword suggestion tool updates the list of suggested queries. The newly-updated list consists of suggested queries that incorporate the one or more keywords used or selected during the preceding search. This way, a user can methodically go through the search in a hierarchical order, and can perform a number of related searches by merely selecting the queries/keywords suggested by the keyword suggestion tool without typing in new search terms each time. In some embodiments discussed in more detail below, the keyword suggestion tool is configured to support navigation keys that enable the user to navigate through the list of suggested queries, select one of the suggested queries with which to refine the search, and view an updated list of suggested queries without actually invoking an Internet search.

The search tool may be based on a database, which may include a compilation of search terms used by the user and/or by others during previous searches. For instance, even if prior users are not tracked, the queries submitted by the prior users may still be incorporated into the database. As the user types in characters of a keyword, the database may be searched in real time to filter out keywords that do not include the combination of characters, identify those database entries that include the combination of characters, retrieve the keywords associated with the entries, and provide the suggested keywords to the user. Such a database can be generated by compiling and indexing a list of search terms used during previous searches, and ordering them in accordance with their respective frequencies of use. Such a database may, for example, be generated and searched using a database generation and search system based on an index engine similar to the one disclosed in the above-cited U.S. patent application Ser. No. 10/654,596 entitled “Methods and Systems for Web-Based Incremental Searches.” Of course, such a database may also be generated using any other suitable method known to those skilled in the art.

The database may also include information gathered from and associated with the particular user submitting the query. In that case, the database would include keywords or queries previously used by that particular user, and such previously used keywords or queries provided to the user as suggested keywords. One example of using the information regarding previous searches by the same user to realize more efficient searching is disclosed in U.S. provisional application No. 60/612,619 filed Sep. 22, 2004, entitled “Behavioral Search Engine,” the entire content of which is incorporated herein by reference. Another example of using the information regarding previous searches by the same user to realize more efficient searching is disclosed in U.S. provisional application No. 60/616,044 filed Oct. 4, 2004, entitled “Search Results Based on Search User Intent,” and U.S. nonprovisional patent application No. 11/234,769 file Sep. 22, 2005, entitled “Search Engine using User Intent,” the entire content of both of which are incorporated herein by reference. The search method and system disclosed in this application may also be referred to as a “behavioral search engine.”

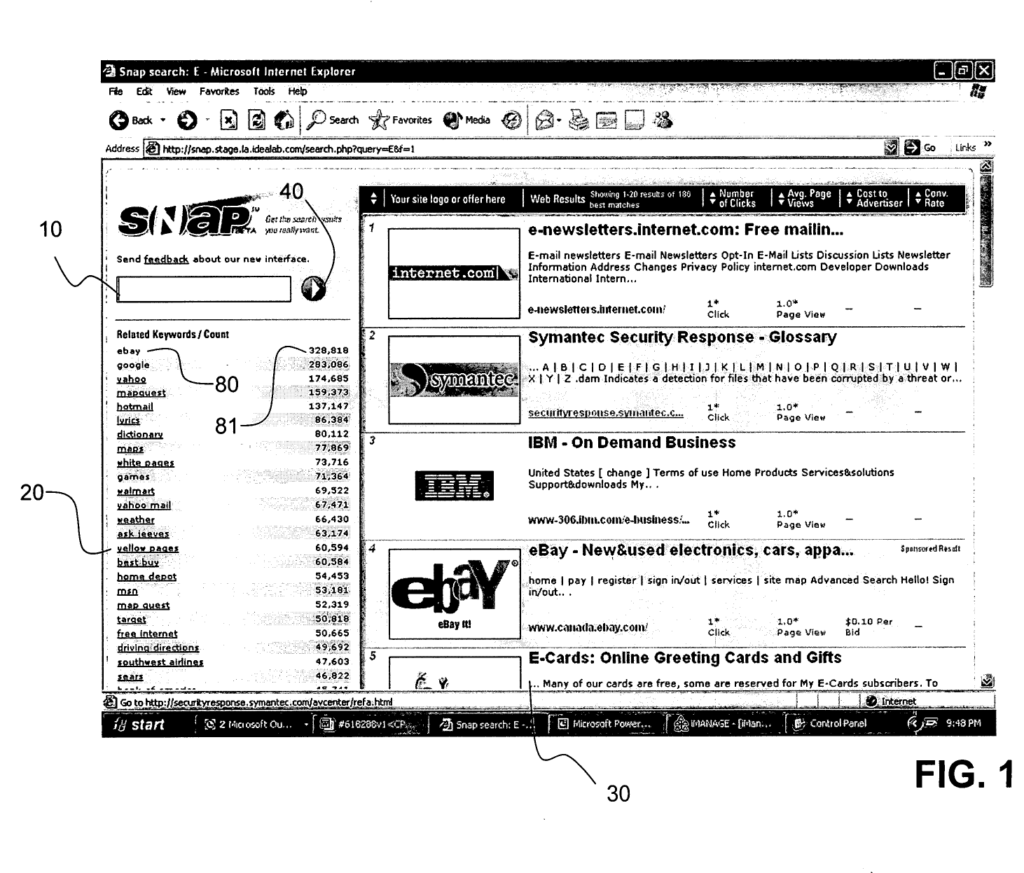

As can be seen in the screen shot of FIG. 1, the keyword suggestion tool provides a user interface window having three main areas, namely, a keyword field 10, keywords area or pane 20 and a search result area or pane 30. The user interface window appears in a frame generated by the web browser. Prior to entry of a query or keyword into the keyword field 10, the window may display pre-determined content selected by the search engine. Hence, the search result area 30 may show the result of a previous search prior to performing another search. On the other hand, the keywords area 20 shows a plurality of suggested keyword including the most popular queries 80 received by the associated search engine, i.e., a list of some keywords or search terms in the database ordered in accordance with how many times the term has been used during searches tracked by the database generation system. The popularity rank, i.e., the number 81 of times the associated query has been executed, may also be displayed in proximity to the associated query 80.

A user then initiates a search by entering a query into the keyword field 10 in the manner described below. The search of the term or any portion thereof may be executed, for example, by pressing a search button 40 located next to the keyword field 10. In addition, a search can be invoked using any of the suggested keywords in keywords area 20 by selecting (e.g., through mouse clicking) one of the keywords or queries.

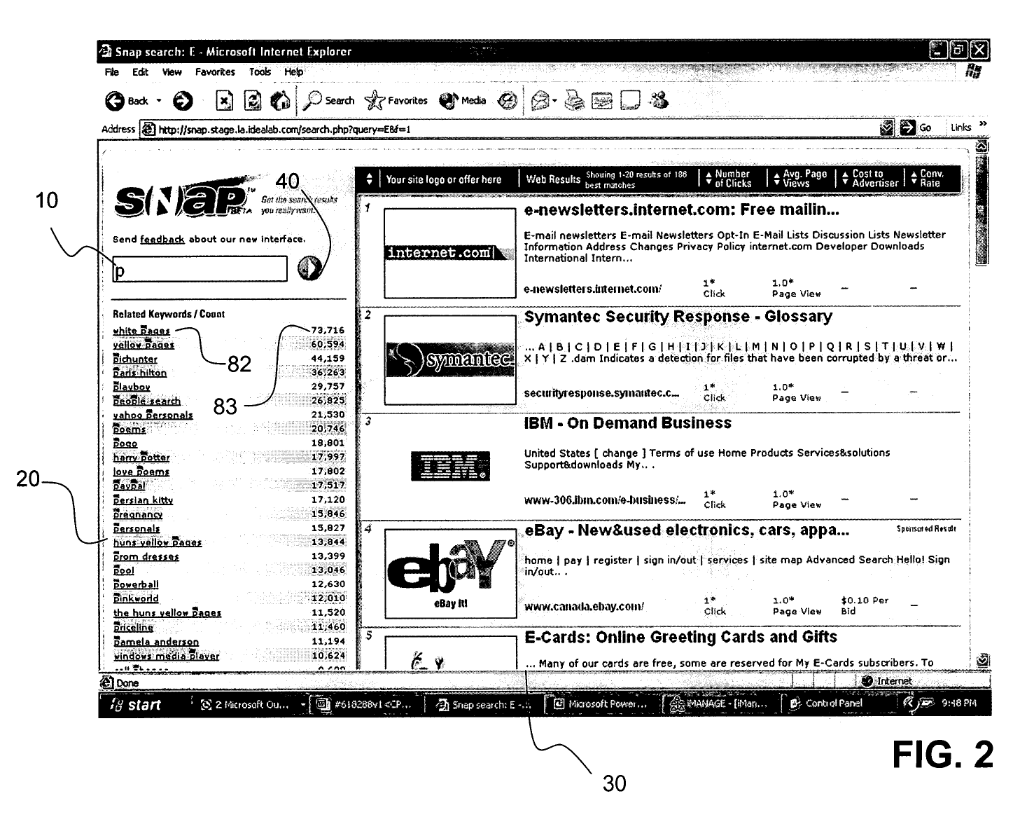

As stated, some embodiments include an “as fast as you type” feature that attempts to predict the user's query based on one or more letters and keywords entered by the user. When a character “p” is typed into the keyword field 10, it can be seen in FIG. 2 that the keyword suggestion tool identifies a number of keywords 82 having the character “p” are displayed in the keywords area 20. These keywords 82 having one or more characters “p” are selected and ordered based on a heuristic. The heuristic (i.e., a set of rules for providing keyword suggestion), in turn, may be based on prior searches, including searches previously conducted by the user currently entering the keyword, prior searches conducted by similarly situated users, or prior searches conducted by users of the tool in general, or any combination thereof. One, straight-forward, heuristic selects and orders the keywords based on how many times the term has been used during such previous searches (e.g., popularity measure 83), which may be tracked by a database generation program. However, more sophisticated heuristics may be deployed, including heuristics that are based on further factors or on factors entirely distinct from prior searches. The straight-forward heuristic described above is to be understood merely as an illustration and does not limit the scope of the invention.

In the preferred embodiment, the list of suggested queries includes a plurality of queries comprising one or more keywords beginning with the letter “p.” The letter “p” may be the first letter of the first keyword or any additional keyword thereafter. By way of example, it can be seen in the keywords area 20 of FIG. 2 that many of the search terms (e.g., “white pages,” “yellow pages”) suggested by the keyword suggestion tool do not start with the character “p”. Instead, they all contain one or more characters “p” in their respective strings. This is because the keyword suggestion tool may take the user's query and match it to the keywords in the database based on both sub-strings and super-strings. In alternate embodiments, the search may be performed based either on the sub-strings or the super-strings only, or may be user selectable. To the immediate left of each keyword in area 20 is a popularity ranking 83 that indicates the number of prior users that have executed the same query.

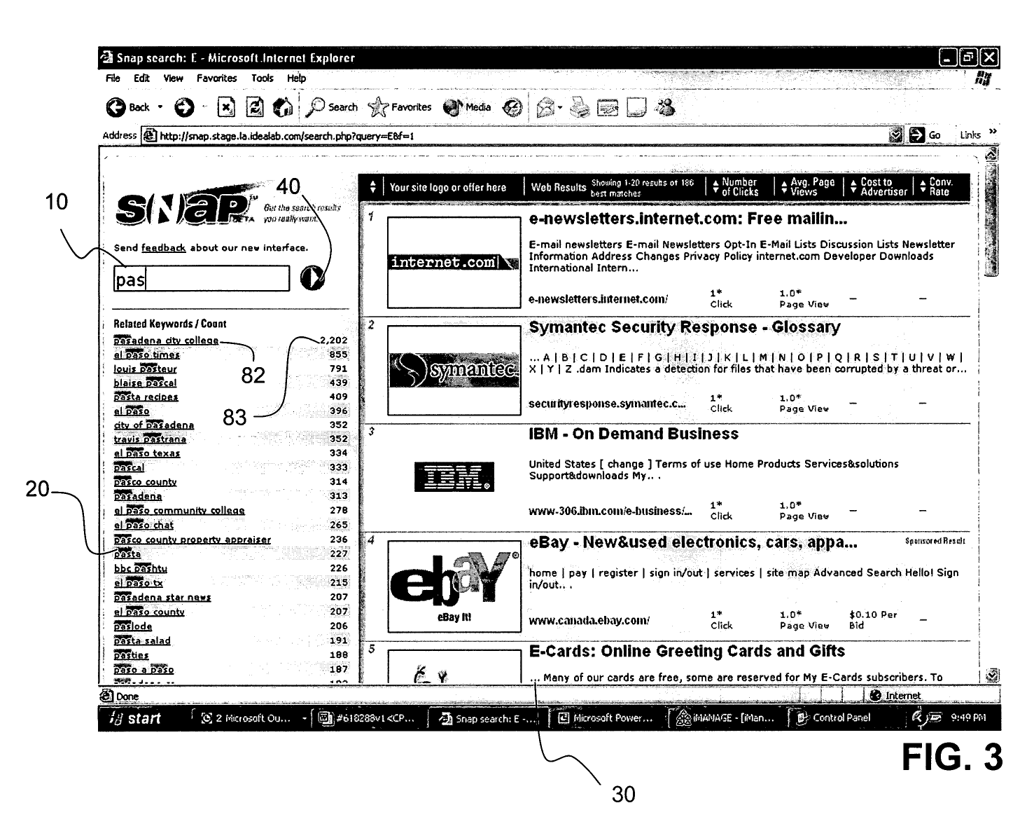

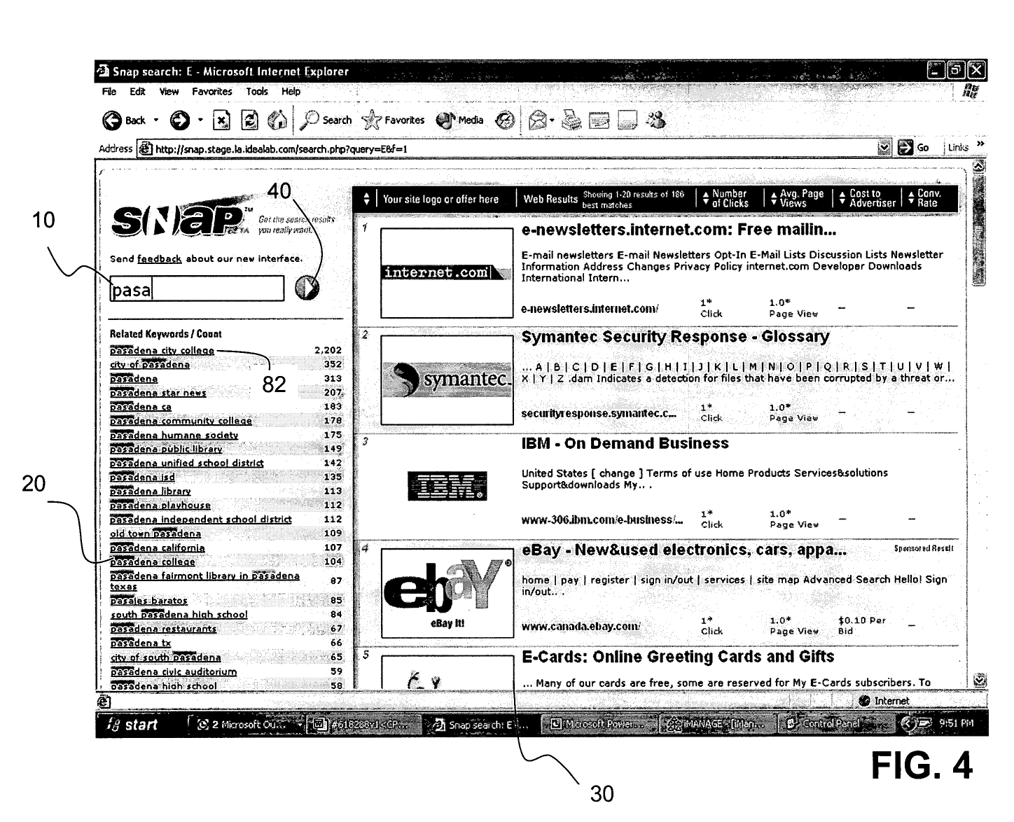

FIGS. 3 and 4 respectively illustrate the changes to the content of the keywords area 20 as the user begins to enter characters for the term “pasadena” in the keyword field 10. As illustrated, the content is revised to include suggested keywords 82 that match the character string “pa” and “pas” (see FIG. 3). In the preferred embodiment, the listing of suggested keywords in keyword area 20 is updated with the entry of each character by the user.

The suggested keywords 82 displayed in the keyword area 20 may be generated in real-time without the user manually entering the entire query or even an entire keyword prior to executing the search. The content displayed in the search result area 30 has not changed since no query has been invoked yet.

In the preferred embodiment, the search result area 30 remains static until the user executes the search by activating the search button 40 or selection of the hyperlink associated with a suggested query, for example. In some embodiments, however, the content of the search result area 30 may be updated in response to the user placing a cursor on the keywords listed in the keywords area 20 and/or using arrow keys to navigate/scroll down in the keywords area 20 and/or the search result area 30. By way of example, by placing the cursor on the “pasadena star news” in the keywords field 20, the search result for the search string “pasadena star news” can be displayed on the search result area 30. This can be realized, for example, by performing a pre-search or by previously performing searches for the keywords, and displaying the result of the search as the cursor is placed on top of the corresponding keyword. Any other suitable method may be used to implement this alternate embodiment.

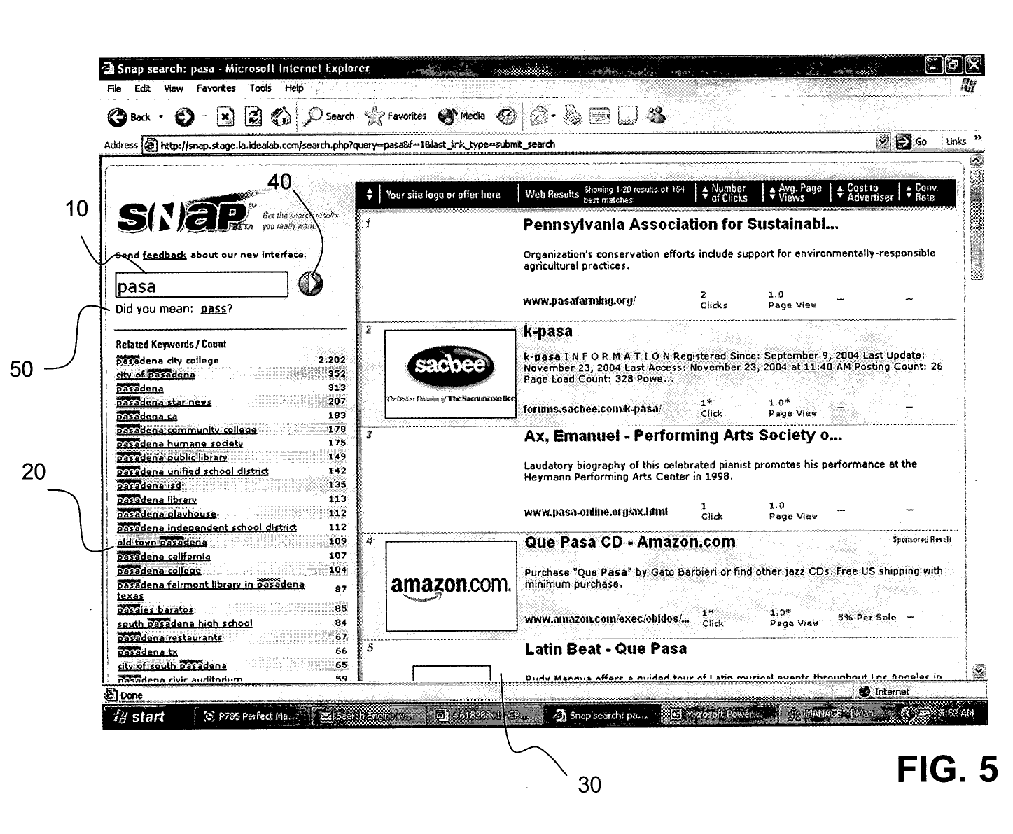

Returning now to the embodiment illustrated in FIG. 4, after typing in the characters “pasa” in the keyword field 10, when the search button 40 is pressed, the search engine performs a search, and provides a search result for the term “pasa” in the search result area 30. Further, as shown in FIG. 5, the keyword suggestion tool provides a question to the user at a location below the keyword field 10, such as “Did you mean: pass?” 50, to ensure that the user has entered a correct sequence of characters.

In an alternate embodiment, the keyword suggestion tool may have an auto-completion feature. Using this feature, the keyword suggestion tool will complete the keyword or string that the user is entering in the keyword field 10. By way of example, the keyword suggestion tool having the auto-completion feature may suggest the search term “pasadena” in the keyword field 10 after the user enters only “pasa”. The user may accept the suggested search term by pressing the search button 40 when the auto-completed suggested search term appears automatically in the keyword field 10. Alternatively, the user may reject the auto-completed suggested search term by deleting the entire search term or by deleting the suggested portion of the search term, and replacing it with the character string intended/desired by the user.

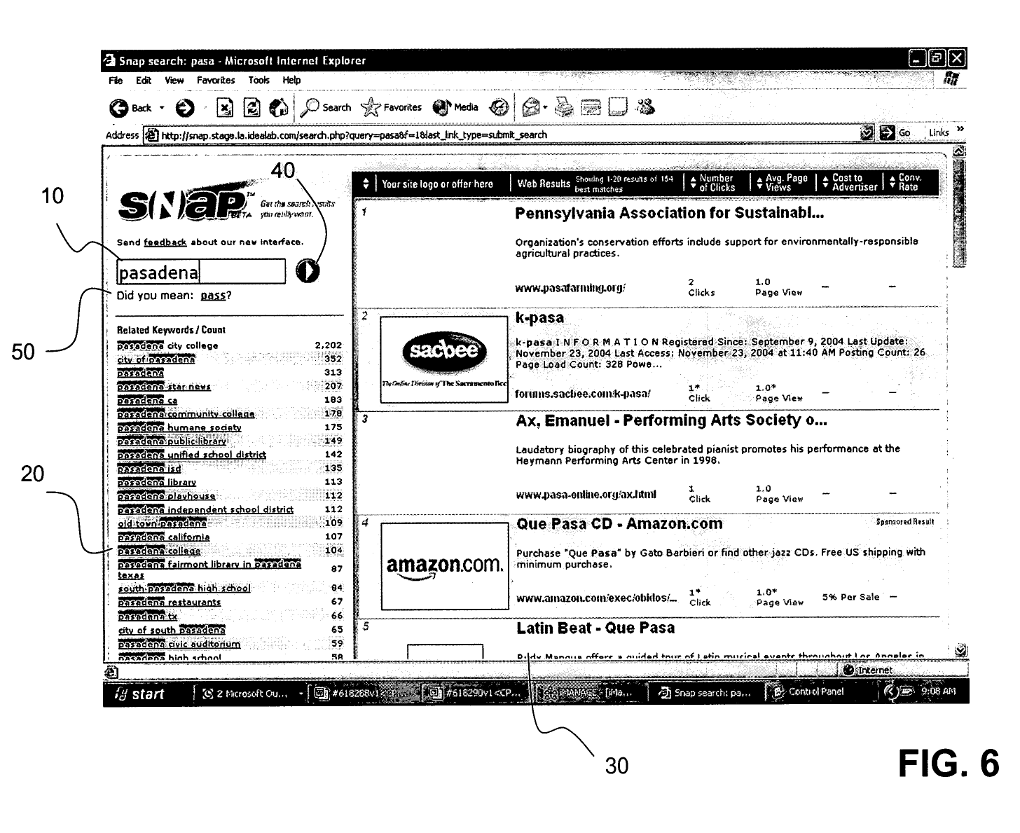

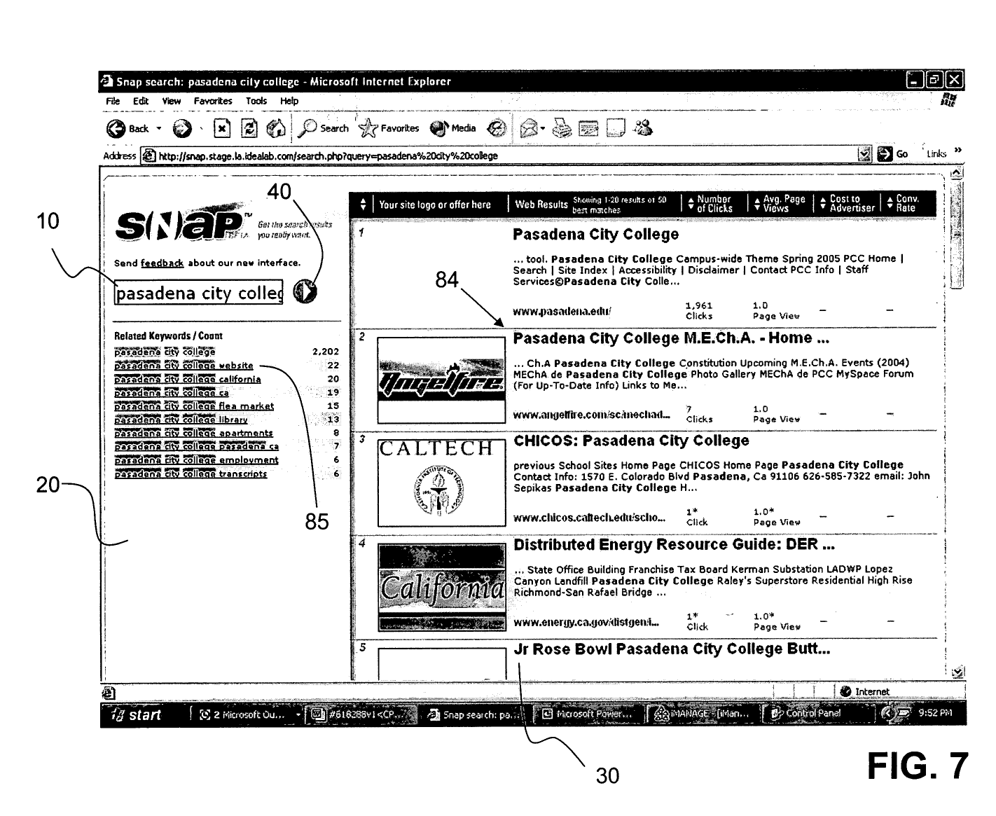

After entering the full keyword “pasadena,” when the keyword “pasadena city college” is selected from the keywords area 20, as shown in the screen shot of FIG. 6, for example, the search result displayed on the search result area 30 changes further to reflect the search that has been performed as can be seen in FIG. 7.

Further, the content of the keywords area 20 changes as well to show only those prior queries that possess the search term “pasadena city college” as a part of the keyword. Further, hierarchical keyword searches at lower levels can be performed by selecting one of the keywords in the keywords area 20, for example.

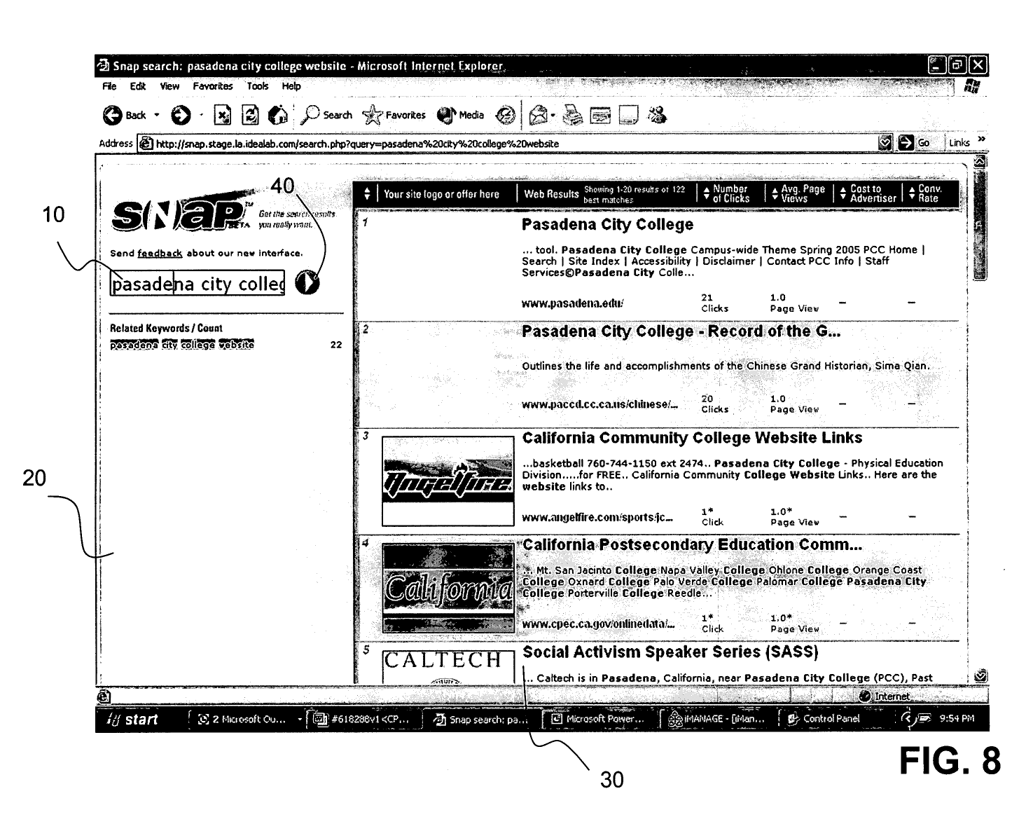

A user interested in viewing the Pasadena City College website may do so by selecting the associated search result 84 shown in FIG. 7, because the search result includes a hyperlink to the official website in the described embodiment. As can be seen in FIG. 8, the user also has the option to narrow the search results by selecting a suggested query from the keywords area 20. After selecting the search term “pasadena city college website” 84, for example, the updated keyword area 20 and search results consist of a reference to the official website.

It can also be seen in the screen shots of FIGS. 2-8 that the portions of the keywords displayed in the keywords area 20 are highlighted in accordance with the characters entered by the user. By way of example, only the character “p” is highlighted in the keywords area 20 in FIG. 1, whereas the entire phrase “pasadena city college website” is highlighted in the keywords area 20 in the screen shot of FIG. 8. Similarly, the screen shots in the other figures show different numbers of characters highlighted depending on the characters already entered by the user.

As described above, the keyword suggestion tool of an exemplary embodiment of the present invention provides suggested keywords or search terms in real time as the user types in one or more alphanumeric characters into the keyword field 10. By selecting one of the keywords, a search can be performed and a search result displayed in the search result area 30. Further, when one of the keywords is selected, the keywords area 20 is updated to show other keywords that contain the selected keyword. This way, a hierarchical search can be performed, in which a user can perform a more detailed search of the selected search term without typing in new terms each time.

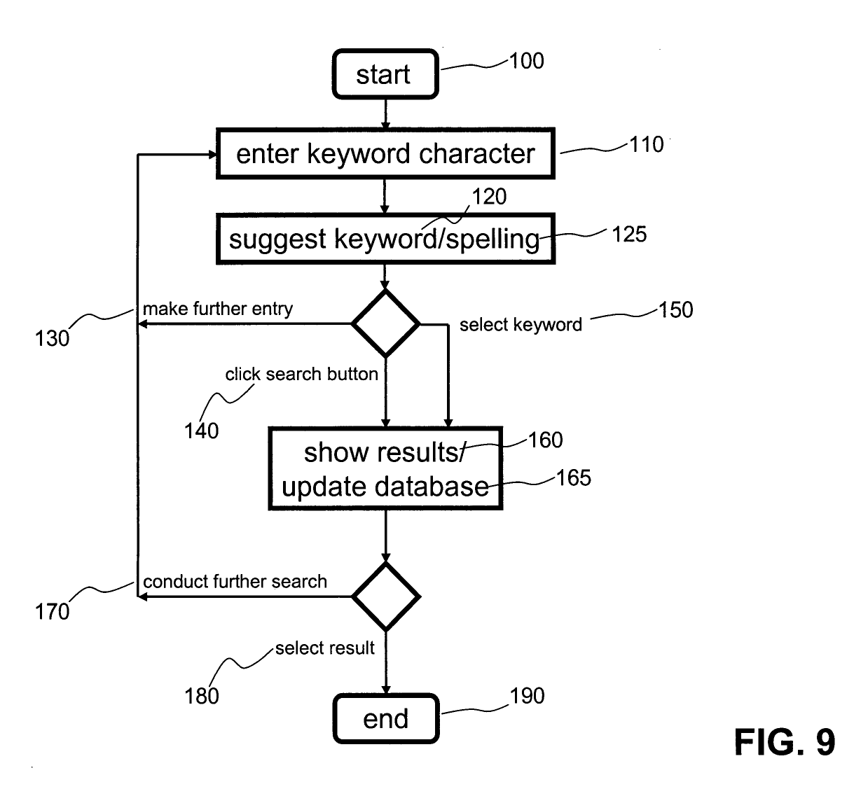

Turning now to FIG. 9, interaction with and behavior of an embodiment of a system in accordance with the present invention is illustrated in more detail:

A user interested in searching for information may start 100 by entering a character 110 of a keyword the user anticipates will lead to desired search results. Upon entry 110 of a character, the system may suggest keywords 120 and/or alternative spellings 125 based on what the user has entered 110. (It should be noted that the system may already make keyword suggestions before any entry has been made, as shown in FIG. 1. Such keyword suggestions may be based on prior searches, user preferences, or any other heuristic.) The user then has a choice of making further entries 130, clicking the search button 140, or selecting one of the suggested keywords 150.

The user may choose to make further entries 130 simply by entering one or more additional characters 110 (as well as modifying previously entered characters) in the keyword field. Upon the further entry, the system may modify and/or update the list of suggested keywords 120 and/or suggest other alternative spellings 125. While entering/modifying characters, the user continues to have a choice of making further entries 130, clicking the search button 140, or selecting one of the suggested keywords 150.

If the user chooses to click the search button 140, the system may execute a search and display search results 160 in the search result field. The system may also update its database 165 to reflect the executed search, allowing the system to use the search and its results as data when making suggestions during future searches.

Instead of clicking the search button 140, the user may also select a suggested keyword 150, thereby executing a search for the selected keyword rather than the entered keyword. If the user selects a query 150, the keyword area 20 is updated with suggested queries that match the selected query. Again, the system may display the search results 160 in the search result field and may update its database 165 to reflect the executed search.

Once a search has been executed and the search results are displayed 160, the user may select one of the search results 180 and finish 190 its search. Should the user not be satisfied with the search results (whether the user was not satisfied with the displayed list in the first place, or whether the user, upon inspection of one or more of the search results, which may include following links to Internet sites corresponding to search results and inspecting those sites, decides that further search results are desired), the user is always free to conduct further searches 170. The user may, of course, also, at any time, abort one search and simply begin modifying/entering characters 110 in support of another search, without ever having executed the earlier search (i.e., without having clicked the search button 140 or selected a keyword 150). As this choice is implicit in the continuous option of modifying and entering keyword characters 110, this choice has not been illustrated explicitly in FIG. 9.

The flow illustrated in the chart in FIG. 9 is to be understood to be merely illustrative of one exemplary embodiment and not as restrictive. Many variations are contemplated and included in the scope of the present invention, including changing the order of individual steps and/or executing steps in a parallel manner that are shown in sequence in the chart. One example of parallel execution may be the updating of the database 165, which may happen as soon as a search is executed 140, 150, before, during or after display of the search results 160, possibly while the user is conducting further searches 170 or after the user has finished the search 190 and/or while the user is selecting 180 or inspecting search results. The actual timing of the execution of these steps may often depend on other factors, such as network speed and traffic, and is not restricted simply because of the specific order that has been chosen for FIG. 9 in order to provide a readable chart for illustrative purposes.

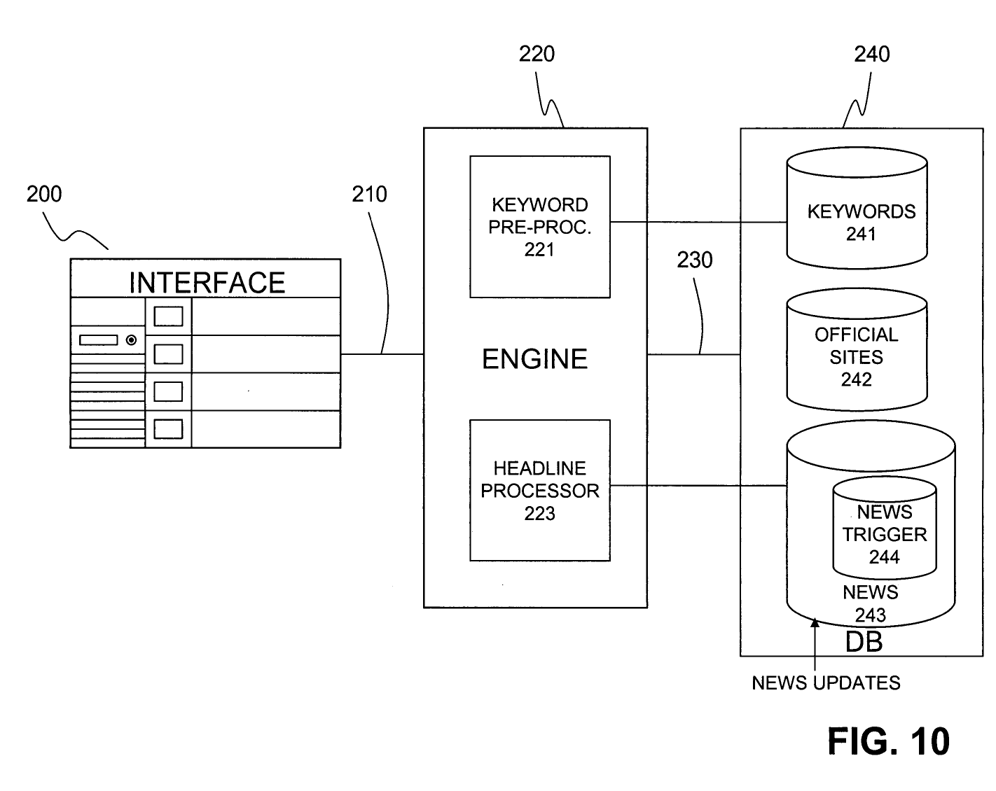

FIG. 10 shows an architectural overview of an exemplary embodiment of the tool. As already described above, the tool includes an interface 200, which may include a web browser configured to view websites or other content accessible via the Internet. The interface 200 is linked 210 to an engine 220 (or a processor). The link 210 may be of any scale and may include network links via networks of any size, including local area networks (LANs), metropolitan area networks (MANs), wide area networks (WANs), and the Internet, as well as any combination thereof. The link may also be physical or virtual.

The engine 220 may perform computations for implementing a heuristic for selecting and ordering suggested keywords. The engine 220, may, for example, be stored on an Internet server, which serves visitors of an Internet site via interface 200. The engine 220 is then further linked 230 to a database 240. The link 230 may, again, be of any scale, including network links, and may be physical or virtual.

In the described embodiment as shown in FIG. 10, the engine 220 includes a keyword pre-processor 221 (or search term pre-processor) adapted to generate synonyms for keywords (or search terms) as will be described later. The engine 220 also includes a headline processor 223 adapted to trigger news headline suggestions as will be described later.

The database 240 may be used to store data usable for a heuristic to select keywords and/or determine an order for selected keywords. The database 240 may contain information about prior searches by users of the tool (as well as other behavioral data), user preferences, as well as any other information that may be useful to suggest keywords. The data may be stored using any structure, including but not limited to structures that allow for quick retrieval of keywords based on partial keyword entries (such as part of a word, term or phrase, and including single characters, as well as any other portion of a keyword or keywords) and may include relationships (possibly weighted) between entries to allow for selecting and/or ordering keywords based on the relation to other keywords.

In the described embodiment, the database 240 includes a keywords database 241 (or search term database) that stores prior queries and/or keyword (or search term) entries, an official sites database 242 that contains entries corresponding to official sites, and a news database 243 that contains new articles as well as a news trigger database 244. In this embodiment, the news database 243 is automatically and continuously updated with current news. While the keywords database 241, the official sites database 242 and the news database 243 are shown in FIG. 10 as three separate databases, the present invention is not limited thereto, and all of the databases 241, 242 and 243 may be implemented in a single integrated database, or each may constitute a number of sub-databases. By way of example, while the news trigger database 244 is shown as included in the news database 243 in FIG. 10, the news trigger database may be implemented as a separate database. Of course, the database 240 may also contain databases other than those shown in FIG. 10.

When a user begins entering the characters of a keyword using the interface 200, the interface may convey the partial entries to the engine 220 via the link 210 as the user is typing. The engine 220 may then, in turn, access the database 240 via link 230 to retrieve data usable to apply a heuristic to select and order keywords that may be suggested to the user. Such keywords may then be submitted via link 210 to interface 200, which may display an (ordered) list of keywords for the user as hyperlinked texts, for example, to enable the user to select the desired keyword through mouse click. In other words, clicking a keyword entry may effectuate entry of the clicked-on keyword in the keyword field and display of search results pertaining to the clicked-on keyword in the search result area.

As the user continues to enter one or more keywords, the interface 200 continues to convey the further entry (i.e., characters and/or keywords entered by the user), as well as modifications (e.g., character entries in addition to characters already entered in the keyword field) to it, via link 210 to the engine 220. The engine 220, in turn, continues to determine suggested queries and their ranking based on heuristics and the data stored in database 240. The suggested keywords and ranks are returned to the user via the interface 200 where they are published.

Of course, any keywords as well as selections of suggested keywords by users may be continuously registered by the tool and stored in the database 240 to be used for suggestions and orders during future searches. As such, the system continuously learns from its use and becomes increasingly effective the more it is used. The system is therefore particularly valuable for Internet search portals that execute large numbers of searches by a great variety of users.

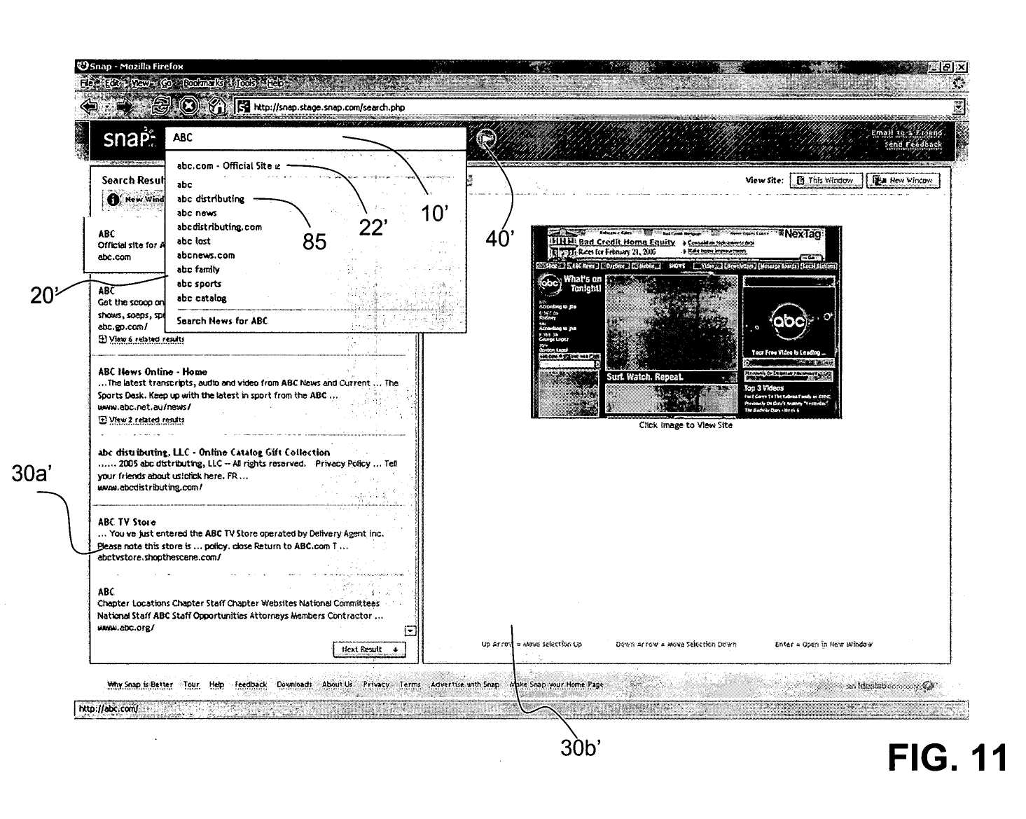

FIG. 11 shows another exemplary embodiment of the present invention. In this particular embodiment, the user interface includes a keyword field 10′, a search result area, and a keyword area 20′ which may be temporarily displayed below the keyword field 10′. By way of example, the keyword area 20′ may be implemented as a pop-up window (or drop-down menu) in one embodiment. In other embodiments, the keyword area 20′ may be implemented in any other suitable manner as those skilled in the art would appreciate.

The search result area is divided into a text-based preview pane 30a′ and a graphical preview pane 30b′. In this particular embodiment, the graphical preview pane 30b′ has been configured to show a single graphical preview of a search result selected in pane 30a′, generally allowing the user to read at least a portion of the text in the graphical preview and thereby gain a better understanding of the associated web site without redirecting the user interface to the site.

The keyword area 20′ in some embodiments is a drop-down menu 20′ with which the user may view and select suggested keywords 85 identified by the keyword suggestion tool as the user enters a query in the keyword field 10′. In general, the list of suggested keywords includes one or more known queries conducted by prior users that match the one or more characters entered by the user. The suggested keywords presented in the drop-down menu 20′ may be continually updated in real-time as the user enters each character. The drop-down menu 20′ appears when the user begins entering characters in the keyword field 10′ and disappears when a search is invoked. The term “drop-down menu” as used herein refers to a menu that may be pushes down, up, or to the left or right from the keyword field 10′.

In the preferred embodiment, the drop-down menu 20′ is a temporary display feature that persists while the object associated with the keyword field 10′ is active. In particular, the drop-down menu 20′ automatically appears when the user enters a query or places the cursor in the keyword field 10′. The drop-down menu 20′ may be superimposed over a portion of the search result area in the region in proximity to the keyword field 10′.

The drop-down menu 20′ then persists until the user invokes a search or selects a search result. The user may invoke a search by depressing the search button 40′ to execute a search of the keyword entered by the user. The user may also execute a search by selecting one of the plurality of suggested keywords presented in the drop-down menu 20′. A suggested keyword is generally selected by first navigating to the appropriate keyword with arrow keys and then hitting the “enter” or “return” key, for example. After the search is executed, the drop-down menu 20′ disappears and the underlying search result area brought to the forefront of the user interface once again. As one skilled in the art will appreciate, the drop-down menu 20′ is generated automatically for the convenience of the user while completely avoiding the need for dedicated pixels or “real estate” on the user interface.

FIG. 11 further shows the embodiment's “Official Site”—feature. Many corporations, organizations, institutions and other entities designate certain web sites as their official site. In such cases, the tool may not only suggest keywords or alternative spellings, but further identify and suggest such official sites. In FIG. 11, a hyperlink 22′ to the official site of ABC (the “American Broadcasting Company”) is indicated in the keywords area (or drop-down menu) 20′, after a user has entered the term “ABC” in the keyword field 10′. The hyperlink 22′ to the official site is, in the preferred embodiment, positioned at the top of the drop-down menu 20′ where it is readily accessible to the user. The hyperlink 22′ to the official website may be segregated from suggested keywords below by a line, bar, or divider, for example.

The “Official Site”-feature is implemented in the described embodiment using the official sites database 242 (shown in FIG. 10). The official sites database 242 in one embodiment is built or generated by human editors. In other embodiments, the official sites database 242 may be generated using automated or semi-automated processes. Each entry in the database 242 contains a keyword or term that matches an official site of a company. As shown in FIG. 11 and described above, a keyword can be ‘ABC’ and the matching official site will be ‘abc.com’. As such, when a user enters a query that matches a keyword in the official sites database 242, the corresponding official site is suggested.

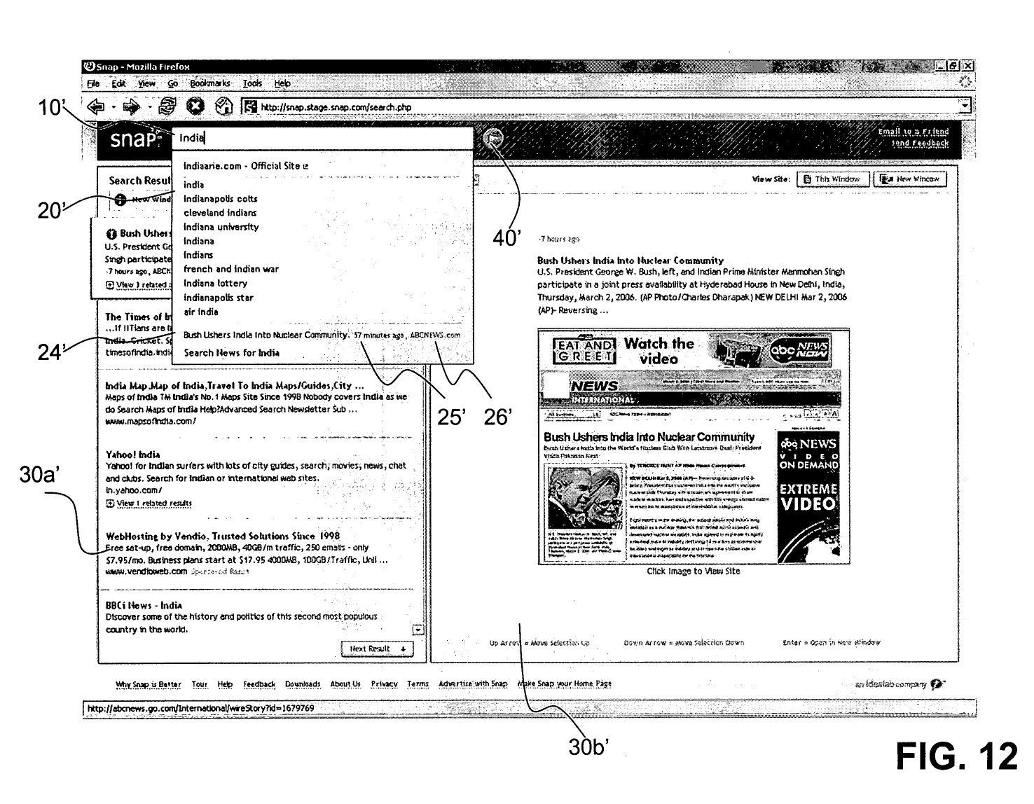

FIG. 12 illustrates the embodiment's news feature. Here, a user has entered the search term “India” in the keyword field 10′. In addition to the other suggestion keywords presented in the keywords area of the virtual menu 20′, the tool also lists a recent headline 24′, including how recently the news has been made available 25′ and by whom 26′, e.g., the age of the new report in hours/minutes and the news organization from which the report originates.

Referring back to FIG. 10, while FIG. 10 shows only the interface 200 and the database 240 respectively coupled to the tool's engine 220 through the links 210 and 230, those skilled in the art would appreciate, that the engine 220 may be directly or indirectly coupled to a number of other devices and/or networks, such as the Internet. The tool may, for example, access one or several news outlets or providers to gather and retrieve news information. Referring back to FIG. 12, here, the interface indicates to the user that the news headline 24′ has been provided by the Internet news provider ABCNEWS.com 26′.

The news feature in the described embodiment is implemented using the headline processor 223 and the news database 243, which is automatically and continuously updated with current news. Hence, the news database 243 is a database of news articles that is continually being updated with fresh news articles. The headline processor 223 is an automated process that picks out news headlines from the news database 243, and based on the frequency of common headlines, determines which ones are key headlines for the day. In other embodiments, the key headlines for the day may be determined by human editors or through one or more suitable automated or semi-automated processes, as those skilled in the art would appreciate.

The keywords that appear in the key headline for the day are stored in the news trigger database 244 for a period of time, which may be predetermined. By way of example, in one embodiment, the keywords may be stored in the news trigger database for up to three days before it is removed. If a query entered by the user matches any entry in the news trigger database, the corresponding news headline is suggested in the suggestion tool (i.e., on the interface 200 of FIG. 10).

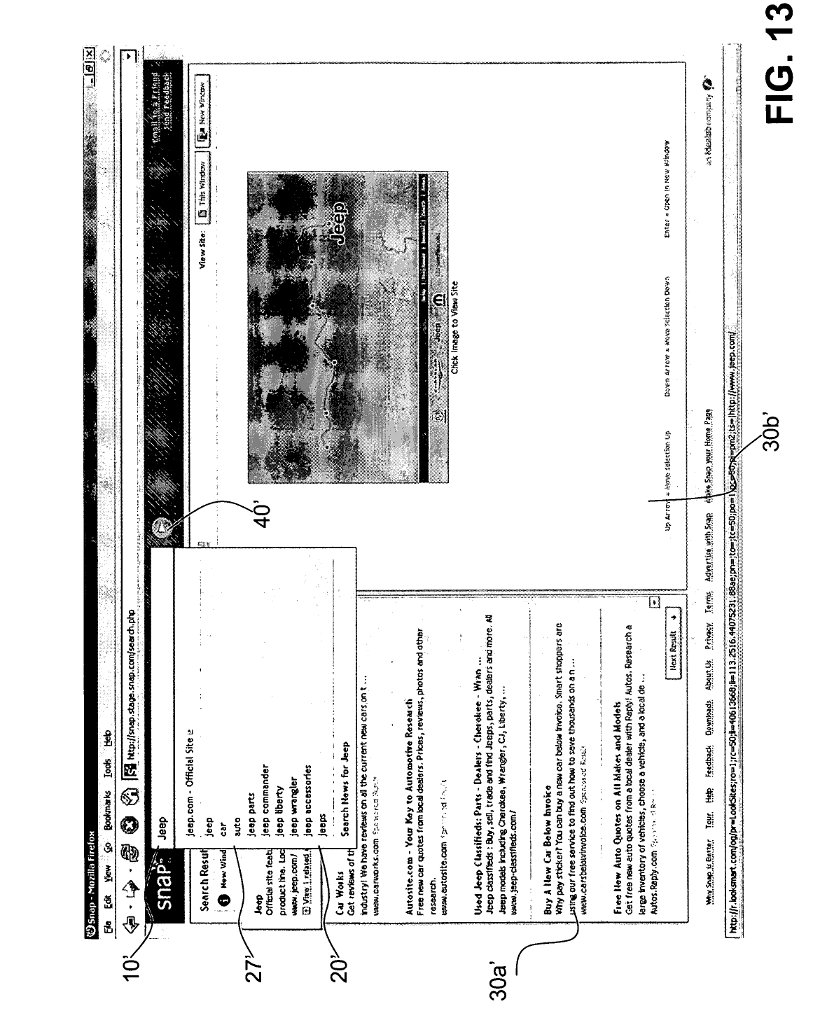

FIG. 13 illustrates the embodiment's “synonym” feature. In the described embodiment, the synonym feature is implemented using the keyword pre-processor 221 together with the keywords database 241. The keyword pre-processor 221 takes all the keywords in the keywords database (or suggestion database) 241, and runs them through Wordnet® (or any other suitable on-line/electronic lexical database and/or thesaurus) to generate synonyms. All the synonyms generated are associated with the original keywords so that queries including the synonyms may be retrieved, ranked, and displayed. For instance, the keyword ‘car’ can generate synonyms such as ‘auto’, ‘vehicle’, etc., and they will all be associated with the keyword ‘car’. When a user types in a query ‘car’, queries including these synonyms can be suggested as well. As can be seen in FIG. 13, for example, after a user has entered the term “Jeep” in the keyword field 10′, the keywords area 20′ does not only suggest keywords that include the term “jeep,” but, realizing that the user may be interested in cars, suggests the alternative keywords “car” and “auto” 27′.

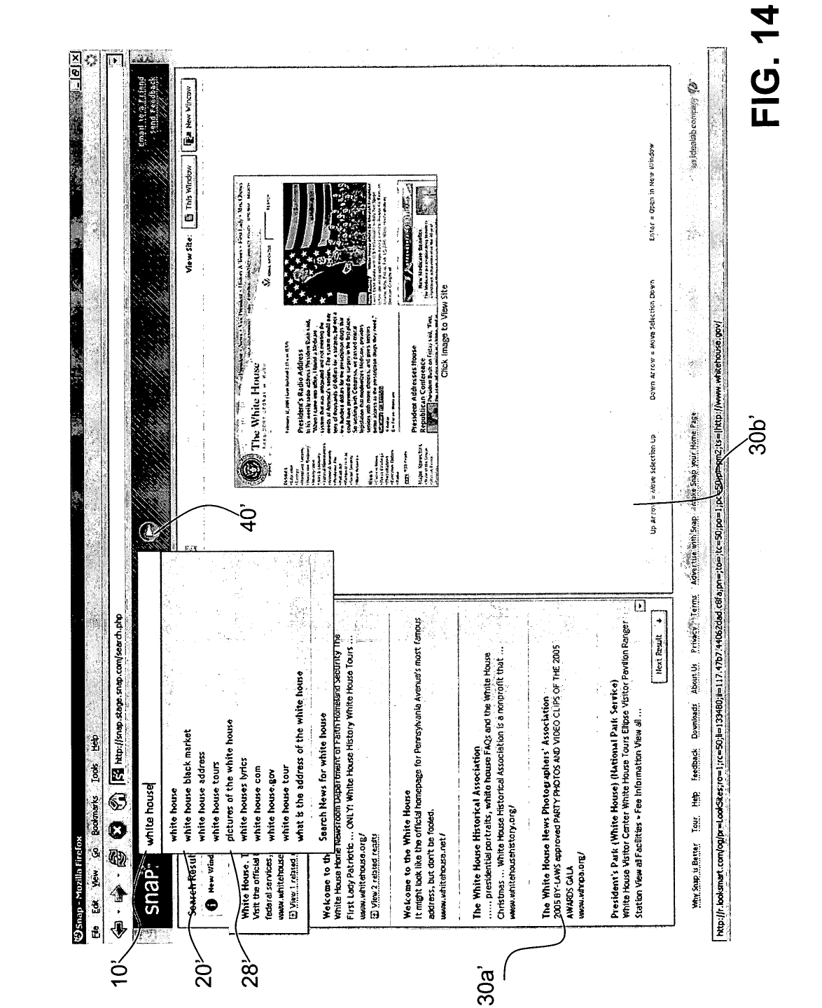

FIG. 14 illustrates the embodiment's reconciliation feature. As already explained, when making suggestions, e.g., for keywords, a tool in accordance with the present invention may rely on entries that have been made by users in the past. However, different users, or even the same user searching at different times, may enter different keywords of the same or similar meaning. Rather than displaying different variations of keywords of the same or similar meaning, the tool may reconcile these variations and suggest only one, or few. The selection of which variation to display, and/or which one not to display, may be based on amount or frequency of use, clarity of the variation, as well as many other heuristics. Similarly, many different heuristics known to skilled artisans are contemplated to decide when to reconcile different keywords in the first place and when not. In the illustration of FIG. 14, the tool has reconciled the keyword suggestions “white house picture” and “pictures of the white house” into a single suggestions of “pictures of the white house” 28′, after a user has entered the term “white house” in the keyword field 10′.

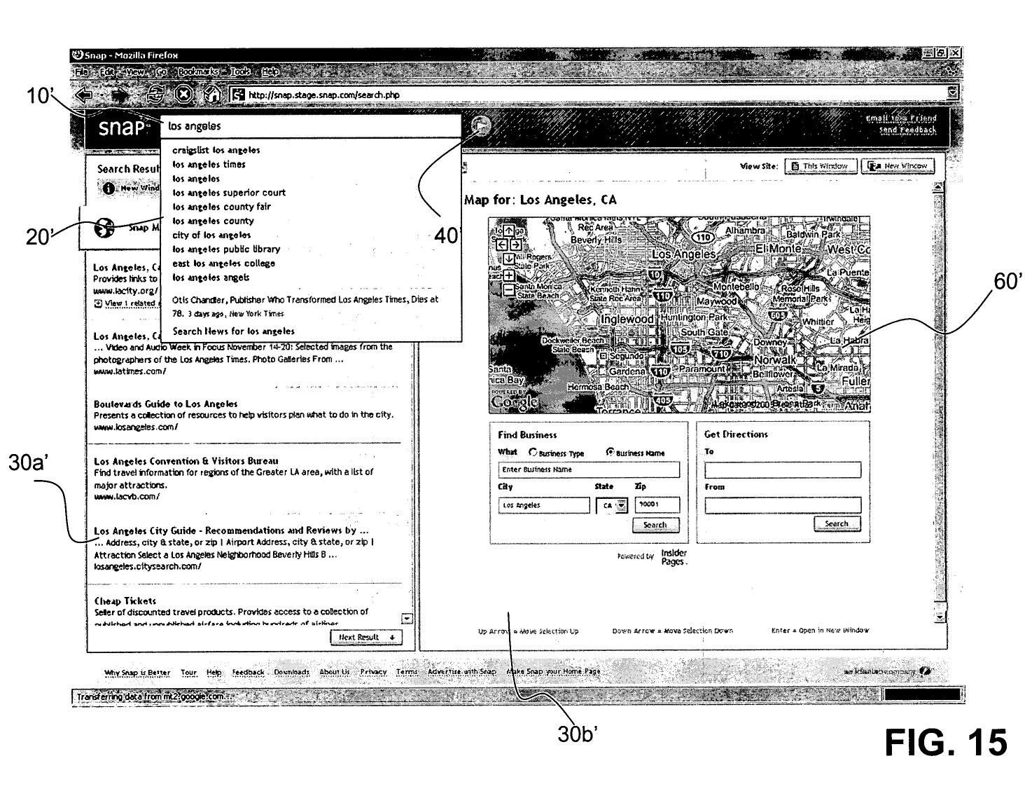

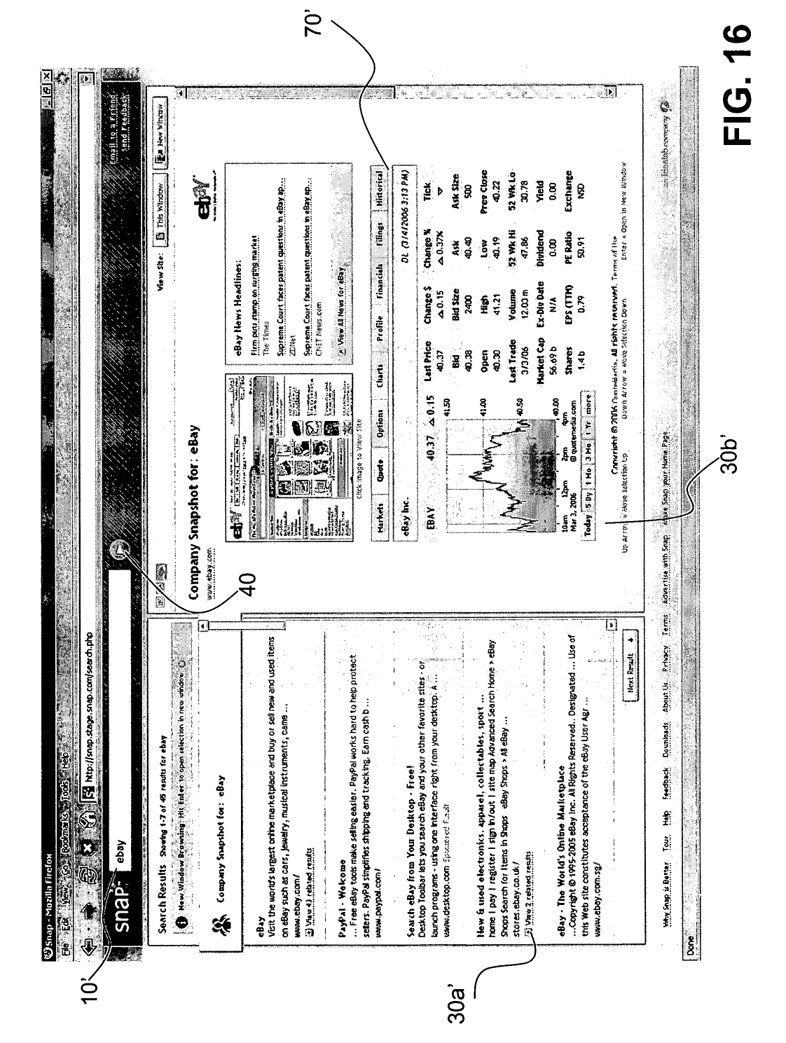

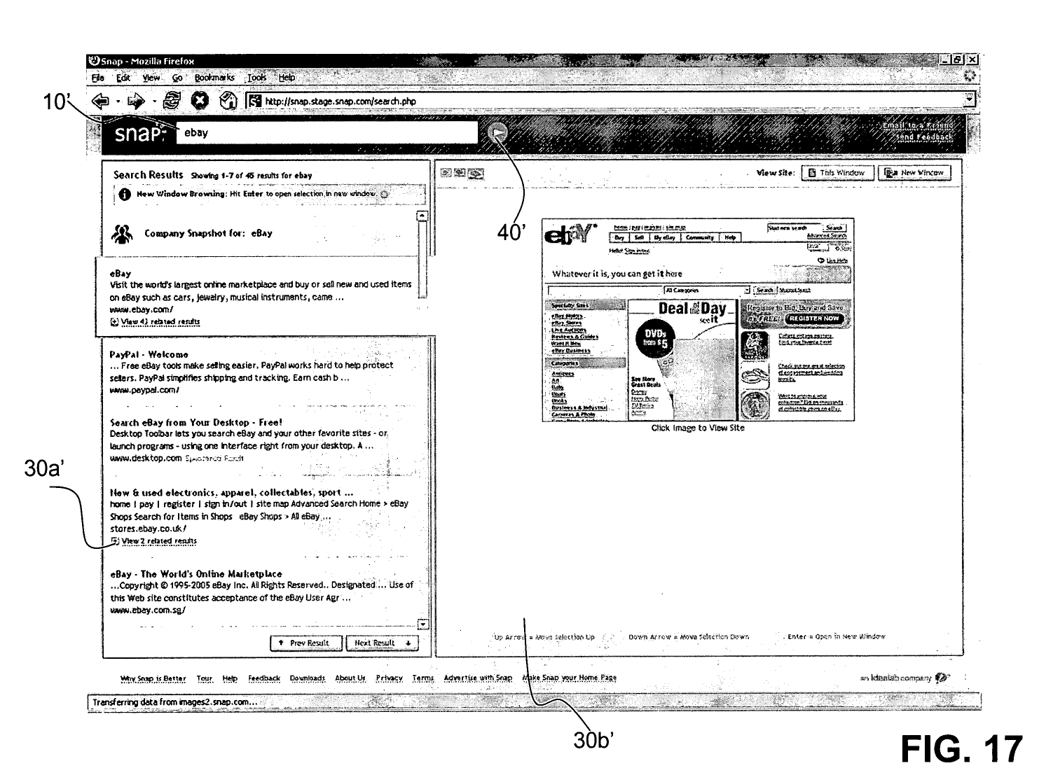

Different embodiments of the present invention may make many other types of suggestions, classifying and/or grouping suggested keywords in ways different from the exemplary embodiments described above. Moreover, the system may provide additional information related to entered or selected keywords, rather than only providing descriptions, previews and links to related web sites. For example, FIG. 15 shows the tool offering a map 60′ of the city of Los Angeles, after a user has searched for the keyword “los angeles.” Similarly, FIG. 16 shows the tool offering company information 70′ on eBay Inc., where a user has searched for the keyword “ebay,” including up to date stock quotes. If the user is not interested in this additional information, a simple click on a search result in the result area 30a′ may update the graphical preview in pane 30b, as shown in FIG. 17, where the user has clicked on the search result linked to eBay's home page.

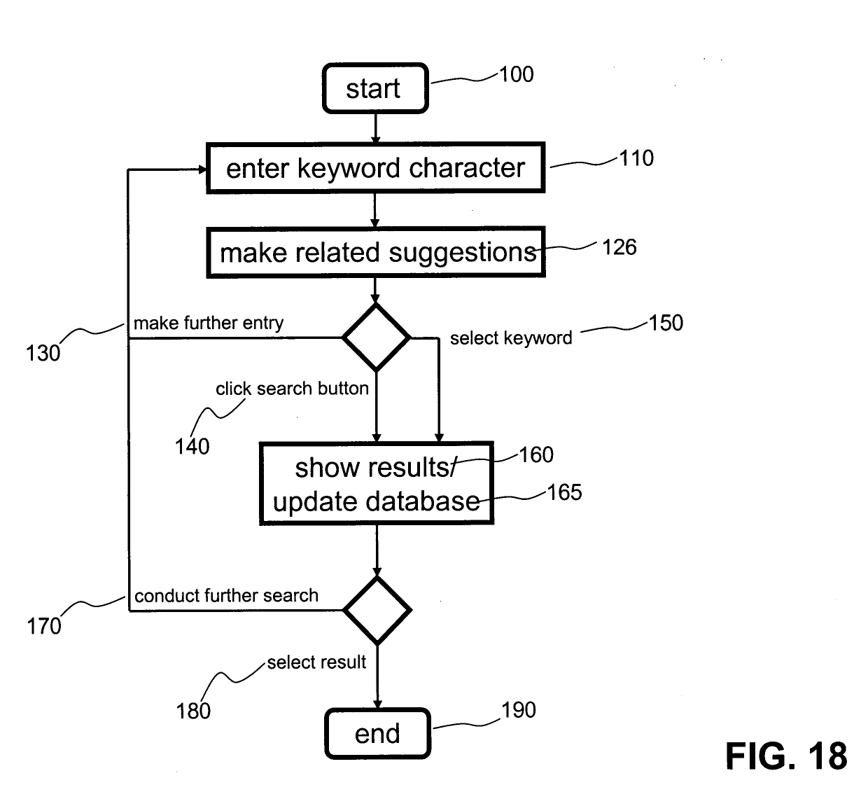

FIG. 18 shows interaction with and behavior of the above exemplary embodiment of the invention. As illustrated for the exemplary embodiment of FIG. 9, a user interested in searching for information may start 100 by entering a character 110 of a keyword the user may believe to lead to desired search results. However, upon entry 110 of a character, the system may not only suggest keywords, but make other related suggestions in general 126. These suggestions may include deploying the official site feature or the news feature, but may include many other or different suggestions. Moreover, once the user executes a search, for example by clicking the search button 40 or selecting a suggested keyword 150, the results 160 displayed by the tool do not have to be limited to web sites, but may include additional information, such as the above described display of maps, stock quotes and/or general company information. Display of many other types of additional information known to those skilled in the art is contemplated and hereby included in the scope of the present invention.

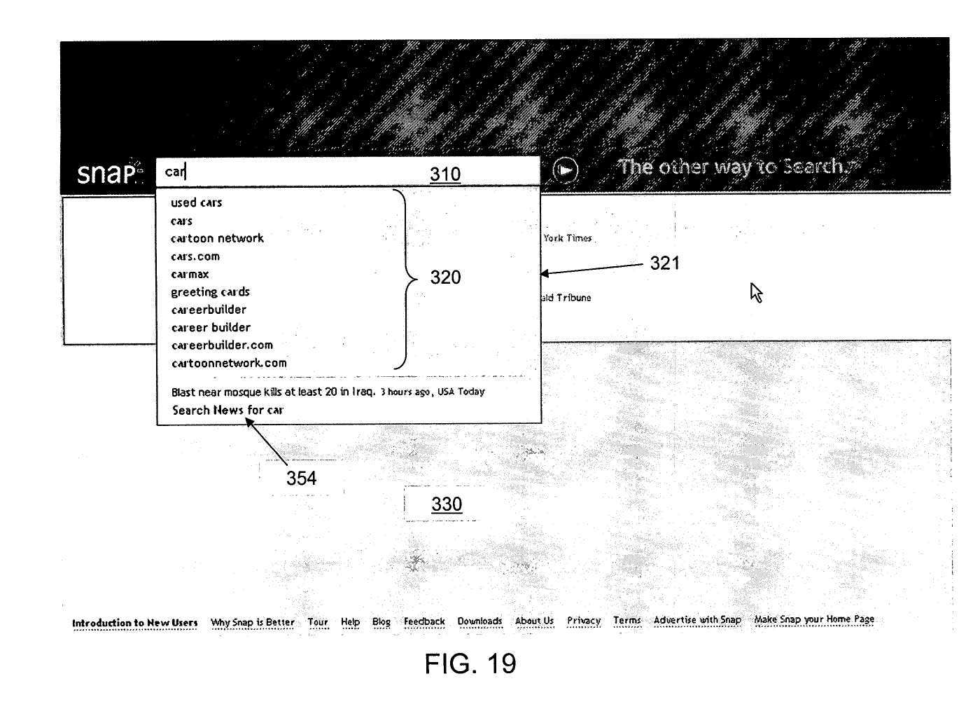

FIGS. 19-22 illustrate screenshots of the user interface of the keyword suggestion tool with hierarchical refinement of the suggested queries. In accordance with some embodiments, the user interface window includes three main areas, namely, a keyword field 310, keywords area or pane 320 and a search result area or pane 330 consistent with the description above. After the user enters the search term “car” illustrated in FIG. 19, the tool returns a plurality of suggested queries 320 that include the term “car.” The suggested queries are presented to the user via a drop-down menu 321 that persists until the search is executed or the user opts to discontinue the search by deleting the term “car”. The plurality of suggested queries 320 generally include the word “car” or have terms than begin with the same letters. Each of the plurality of suggested queries is a hyperlink-type command configured to execute a search of the associated query if invoked by the user.

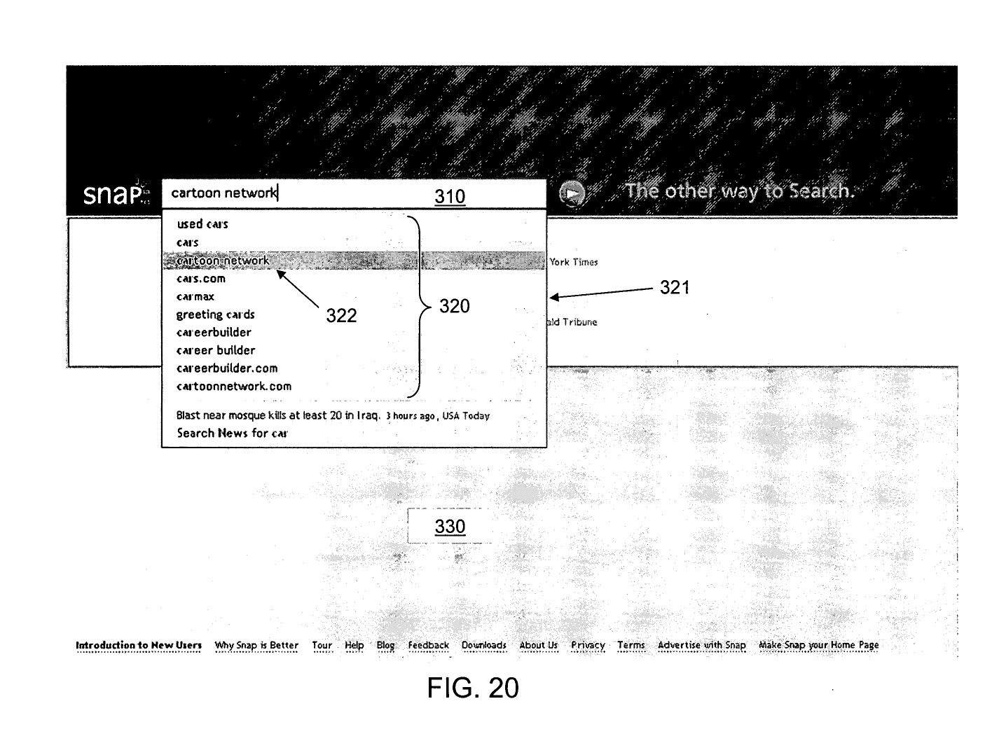

Referring to FIG. 20, the tool in one exemplary embodiment is configured such that the menu 321 may also be navigated with the arrow keys of a keyboard (not shown), for example, to enable the user to focus or highlight a single suggested query in the menu 321. The user may, for example, use a down-arrow key to highlight the suggested query 322 that reads “cartoon network,” which then appears in the keyword field 310. If the user then selects the suggested query by hitting the right-arrow key, the listing of suggested queries in the keywords area 320 is updated based on the terms in the keyword field 310.

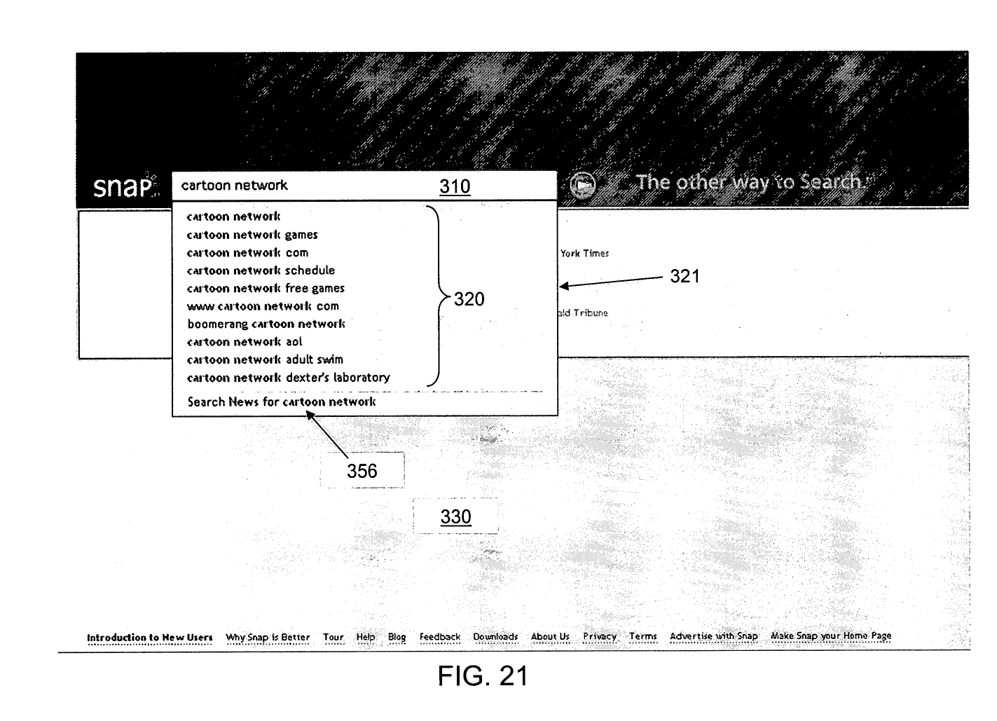

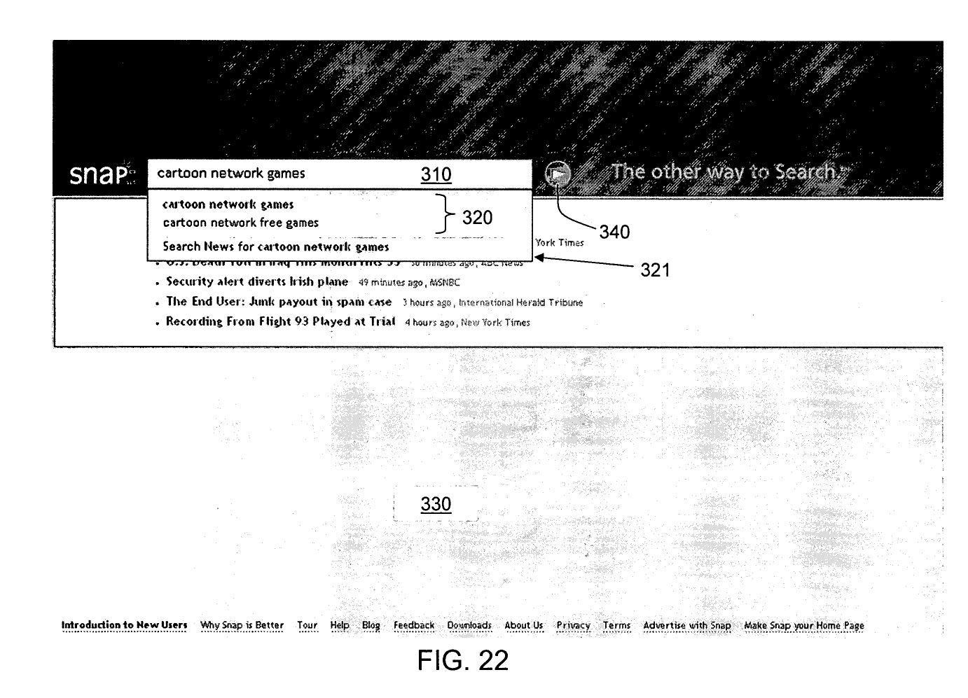

As illustrated in FIG. 21, the listing of updated suggested queries consists of queries that comprise the term “cartoon network” (illustrated in bold font). These updated suggested queries represent a subset of the initial suggested queries, the updated queries being lower in the tree-type hierarchical organization of queries having “car” at its root. Again, the user may use arrow keys to select one of the suggested queries. If the user highlights the query “cartoon network games” and depresses the right-arrow key, the menu 321 is updated and the user presented with the listing of new suggested queries illustrated in FIG. 22.

Up to this point, the user has selected and refined the keywords of his/or her query via the menu 321 without actually executing an Internet search. Thus, there are no search results displayed in the search result area 330. As one skilled in the art will appreciate, the user is therefore able to refine and/or select the terms of the query with minimal keyboard input and no unnecessary search results. The Internet search is only conducted after the user depresses the enter key or clicks on the search button 340, for example. When the search is executed, the drop-down menu 321 disappears and the search results displayed in the pane below the keyword field 310. The search results may be displayed using a graphic interface taught in pending U.S. provisional patent application No. 60/717,547 filed Sep. 14, 2005, and entitled “A search apparatus having a search result selection with matrix display,” the entire content of which is hereby incorporated by reference herein.

In some embodiments of the present invention, the menu 321 is adapted to display non-query content in addition to suggested queries 320. The keyword suggestion tool may be adapted, for example, to present the user with information content in the menu 321 that is based on or responsive to the search terms presently displayed in the keyword field 310. The information content may include, for example, fact, news headlines, stock quotes, and/or weather.

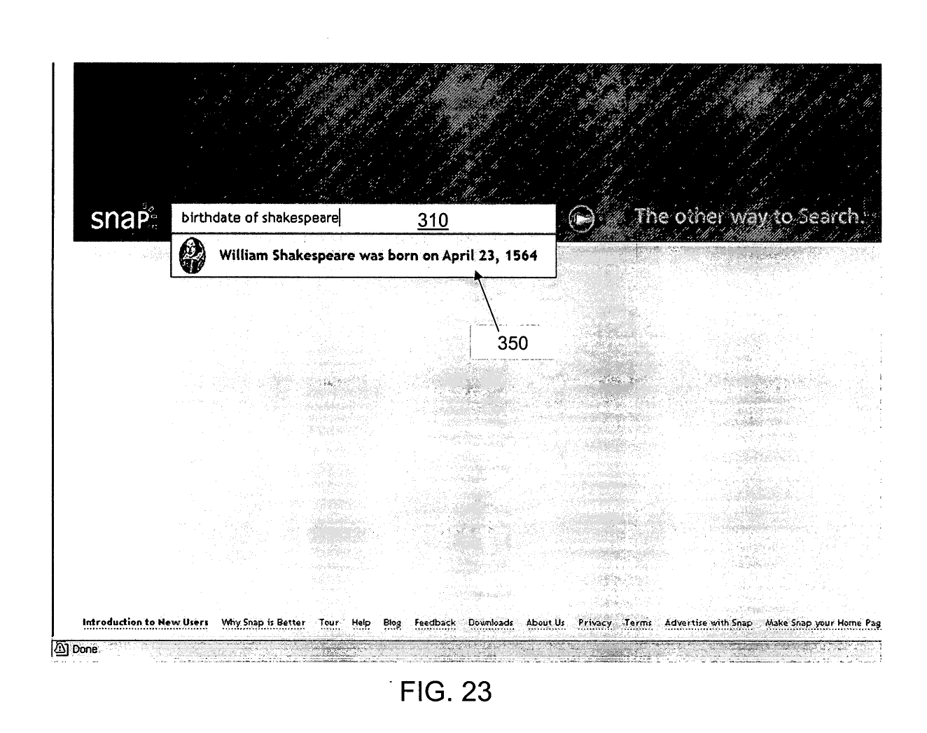

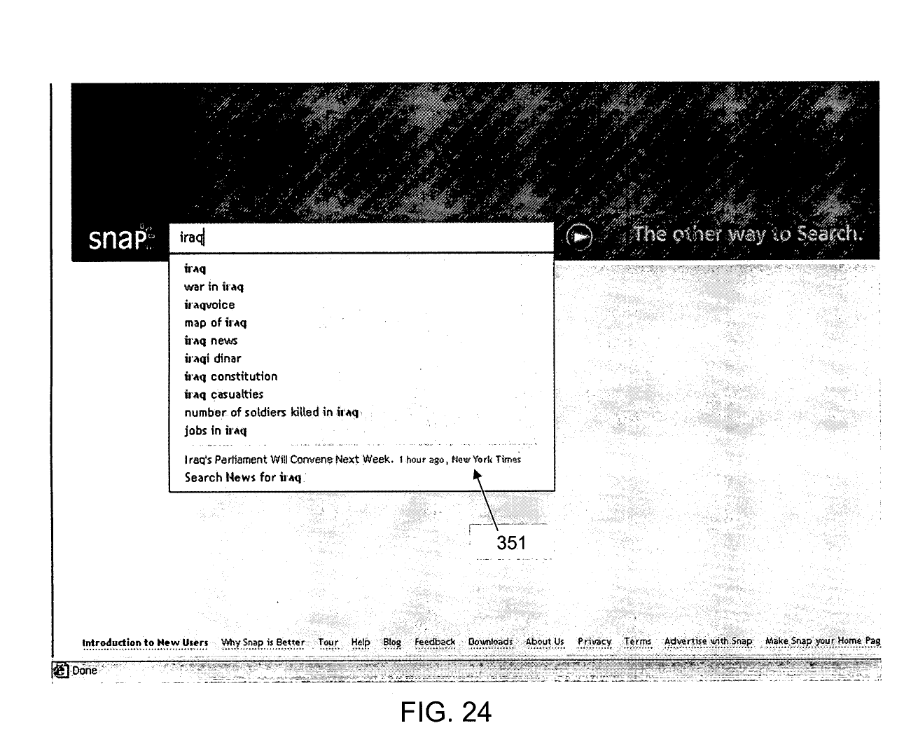

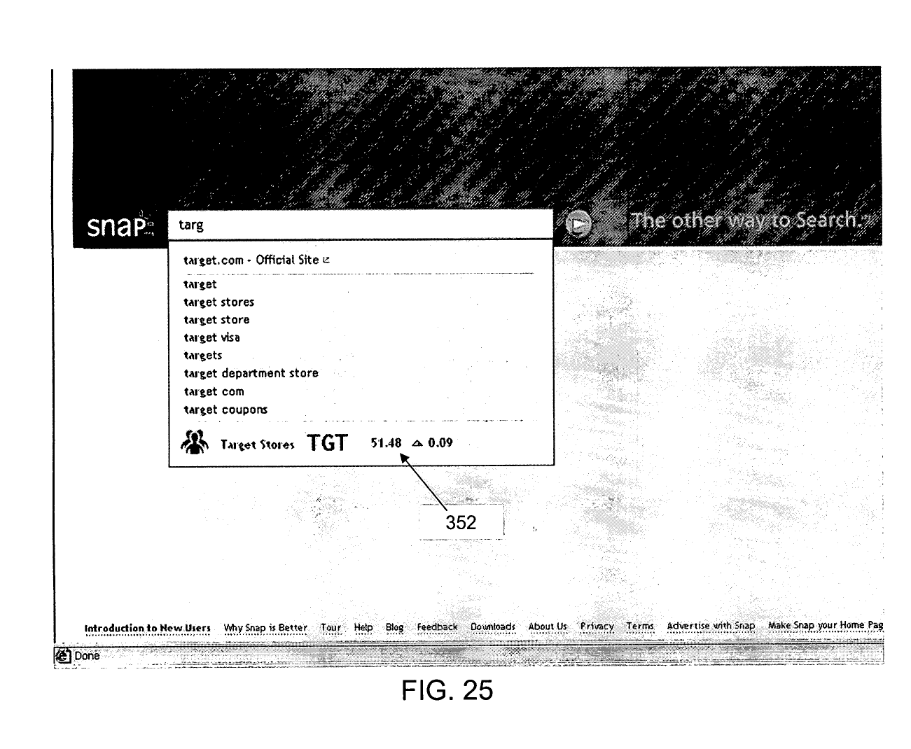

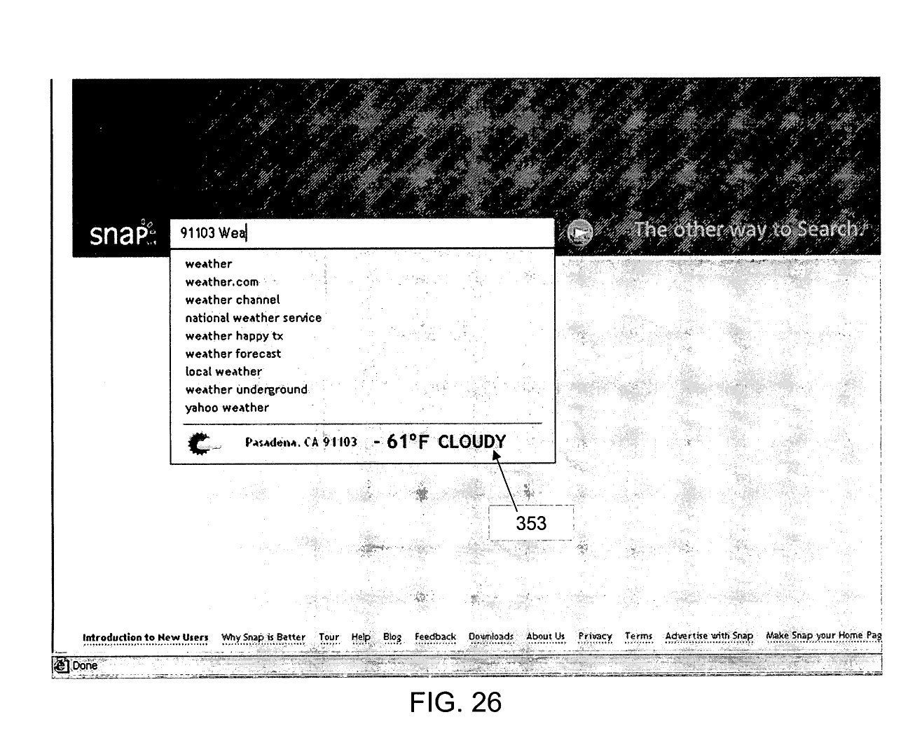

As illustrated in FIG. 23, the tool retrieves and the menu 321 displays Shakespeare's birthday 350 in response to entry of the query “birth date of William Shakespeare.” As illustrated in FIG. 24, the menu 321 displays news headlines 351 or other article clips in response to entry of the term “Iraq” or other word prevalent in the current news. As illustrated in FIG. 25, the menu 321 displays a stock quote 352 in response to entry of a term that matches a company name or ticker symbol. As illustrated in FIG. 26, the menu 321 displays weather information 353 for example, temperature and cloud conditions-in response to entry of an address, city, zip code, or other geographic identifier in the keyword field 310. In this embodiment, the information content is segregated from the suggested queries by a line, bar, or divider.

The drop-down menu 321 in some embodiments may further include one or more suggested queries of a select information category or topic. The suggested query may include the same keywords as those in the keyword field 310, but the Internet search may be limited to a particular one of the plurality of databases 240 when the associated search is executed. Referring back to FIG. 19, for example, the menu 321 includes a category-based suggested search 354 that reads “Search News for car” which, if executed, would be used to generate a list of webpages relevant to “car” from within the News database 243.

As illustrated in FIG. 21, the keywords of the suggested query 356 associated with the news database 243 are updated as the user selects from the plurality of suggested queries 320. That is, the category-based suggested search was updated to include the term “cartoon network” when the user selected that suggested query from the keywords area 320 shown in FIG. 20.

In addition to the News database 234, the category-based suggested searches may be confined to a subset of the Internet index associated with various other categories including products, merchandise, jobs, employment, images, groups, videos, music, games, sports, as well as groups including arts, entertainment, business, finance, computers, health, home, recreation, region, places, science, technology, society, and humanities, for example.

While certain exemplary embodiments have been described above in detail and shown in the accompanying drawings, it is to be understood that such embodiments are merely illustrative of and not restrictive of the broad invention. It will thus be recognized that many other modifications may be made to the illustrated and other embodiments of the invention described above, without departing from the spirit or scope of the present invention.

We claim:

1. A method for providing support during an information search, the method comprising:
receiving one or more characters from a user;
comparing the one or more characters to a set of search terms, wherein each of the search terms is associated with a query previously submitted by the user or a prior user;
selecting a subset of one or more search terms within the set of search terms based on the one or more characters; and
returning one or more suggested queries to the user, each of the queries being associated with the subset of one or more search terms.

2. The method of claim 1, wherein the subset of one or more search terms includes at most one term of similar meaning, said similar meaning being determined by a similarity heuristic.

3. The method of claim 1, wherein said selecting the subset comprises selecting one or more search terms that comprise the one or more characters.

4. The method of claim 3, wherein said selecting the subset comprising selecting one or more search terms is repeated upon receipt of each of the one or more characters.

5. The method of claim 1, wherein the information search comprises an Internet search.

6. The method of claim 1, wherein said selecting the subset comprises selecting one or more search terms on the basis of frequency or amount of prior use of their associated queries.

7. The method of claim 1, wherein the suggested queries comprise hyperlinks to web pages.

8. The method of claim 7, further comprising: displaying the suggested queries in a menu configured for the user to select from.

9. The method of claim 8, wherein the menu comprises a drop-down menu configured to:
appear when the user enters the first of the one or more characters from the user; and
disappear when the user invokes a search.

10. The method of claim 9, wherein the drop-down menu is further configured to display supplemental information, wherein the supplemental information is selected from the group consisting of an official Internet site, street map, stock quote, news, articles, at least one synonym for at least one of the search terms, summary information about an associated organizations, and a combination thereof.

11. A tool for providing support during information search, the tool comprising:
a first interface for receiving one or more characters from a user;
a processor adapted to:
compare the one or more characters to a set of search terms, wherein each of the search terms is associated with at least one of a plurality of queries previously submitted by the user or a prior user, and
select a subset of one or more search terms within the set of search terms based on the one or more characters using a selection heuristic; and
a second interface adapted to return one or more suggested queries selected from the plurality of queries to the user, each of the queries being associated with the subset of one or more search terms.

12. The tool of claim 11, wherein the processor is adapted to interface with at least one of a plurality of databases, wherein the plurality of databases are selected from the group consisting of: a search term database for storing the search terms, an official sites database for storing a plurality of official sites corresponding to respective organizations, a news database for storing articles, and a combination thereof.

13. The tool of claim 12, wherein the processor is further adapted to generate one or more synonyms corresponding to at least one of the search terms stored in the search term database.

14. The tool of claim 12, wherein the official sites database is adapted to return one of the plurality of official sites in the official sites database when the user enters a query that matches said one of the official sites.

15. The tool of claim 12, wherein the processor is adapted to select at least one of articles and to present a portion of the selected article to the user via the second interface.

16. The tool of claim 15, wherein the news database comprises a news trigger database for storing one or more search terms associated with the articles.

17. The tool of claim 15, wherein the at least one of the headlines is selected according to a frequency of occurrence of the at least one of the headlines in the news database.

18. The tool of claim 11, wherein the subset of one or more search terms includes at most one term of similar meaning, the similar meaning being determined by a similarity heuristic.

19. The tool of claim 11, wherein the selection heuristic selects the subset of one or more search terms by selecting one or more search terms that comprise the one or more characters.

20. The tool of claim 11, wherein the selection heuristic repeats selection of the subset of one or more search terms upon receipt of each of the one or more characters.

21. The tool of claim 11, wherein the selection heuristic selects the subset of one or more search terms by selecting one or more search terms on the basis of frequency or amount of prior use of their associated queries.

22. The tool of claim 11, wherein the first interface comprises a menu adapted to display the suggested queries.

23. The tool of claim 11, wherein the second interface comprises a menu adapted to display the suggested queries.

24. The tool of claim 23, wherein the menu comprises a drop-down menu configured to:
appear when the user enters the first of the one or more characters; and
disappear when the user invokes a search.

25. The tool of claim 23, wherein the menu is adapted to display information content in addition to the suggested queries.

26. The tool of claim 25, wherein the information content is selected from the group consisting of: facts, news, news headlines, article clips, stock quotes, weather information, and combinations thereof.

27. The tool of claim 23, wherein the tool is adapted for the user to navigate through the suggested queries via keyboard input.

28. The tool of claim 23, wherein the suggested queries are organized in a hierarchical structure comprising at least a first group of suggested queries and a second group of suggested queries, wherein the menu is adapted to display the second group of suggested queries when an associated one of the first group of suggested queries is selected by the user.

29. A computer program product for providing support during information search, the computer program product comprising:
computer readable software for receiving one or more characters from a user;
computer readable software for comparing the one or more characters to a set of search terms, each of the search terms is associated with a query previously submitted by the user or a prior user;
computer readable software for selecting a subset of one or more search terms within the set of search terms based on the one or more characters using a selection heuristic; and
computer readable software for returning one or more suggested queries to the user, each of the queries being associated with the subset of one or more search terms.
